(19) United States
(12) Patent Application Publication
(10) Pub. No.: US 2015/0039357 A1
(43) Pub. Date: Feb. 5, 2015

(54) Systems and Methods for Providing on Demand Business Resources

(71) Applicant: LivelyHood, Inc., Washington, DC (US)

(72) Inventors: Adam SEGAL, Wellesley, MA (US); Jeremy SCOTT, Boston, MA (US)

(73) Assignee: LIVELYHOOD, INC., Washington, DC (US)

(21) Appl. No.: 14/448,459

(22) Filed: Jul. 31, 2014

Related U.S. Application Data
(60) Provisional application No. 61/860,791, filed on Jul. 31, 2013.

(51) Int. Cl. G06Q 10/06; G06Q 10/02

(52) U.S. Cl. CPC G06Q 10/06314; G06Q 10/02
USPC 705/5; 705/7.24

(57) ABSTRACT

Techniques for on demand business resource management are disclosed. In one particular exemplary embodiment, the techniques may be realized as a method for on demand business resource management including receiving, from a requester, a request via a network for a business resource. The method may further include authenticating the requestor, determining, using at least one computer processor, whether one or more available business resources match the request, providing an interactive graphical user interface indicating available business resources, wherein the interactive graphical user interface is configured to update the interactive graphical user interface to indicate available business resources meeting the business resource criteria, and displaying via the graphical user interface indications of one or more people associated with the available business resources. The method may also include receiving from the requester a reservation request for at least one of the available business resources, reserving the at least one available business resource.

### CROSS-REFERENCE TO RELATED APPLICATIONS

This patent application claims priority to U.S. Provisional Patent Application No. 61/860,791, filed Jul. 31, 2013, which is hereby incorporated by reference herein in its entirety.

### TECHNICAL FIELD

The present disclosure is in the technical field of computer technology and business resources. More particularly, the present disclosure is in the technical field of technology's application to commercial real estate for finding, scheduling, accounting for and/or accessing business resources such as for example, a workspace, contacts with specified skills, and/or equipment.

### BACKGROUND

Conventional commercial real estate, such as an office, is typically leased or owned by an individual or company. Tenants typically sign long-term leases (3-10 years) that carve out designated space in a building for commercial occupation. This arrangement requires significant upfront capital, as well as enough employees to fill the space and make it a viable business solution. Further, individuals and small companies do not always have access to this type of space due to these upfront costs.

### SUMMARY OF THE DISCLOSURE

Techniques for on demand business resource management are disclosed. In one particular exemplary embodiment, the techniques may be realized as a method for on demand business resource management including receiving, from a requester, a request via a network for a business resource including at least one of: a workspace, a meeting space, and an event space. The method may further include authenticating the requestor, determining, using at least one computer processor, whether one or more available business resources match the request, providing an interactive graphical user interface indicating available business resources, wherein the interactive graphical user interface is configured to accept parameters specifying business resources criteria and to update the interactive graphical user interface to indicate available business resources meeting the business resource criteria, and displaying via the graphical user interface indications of one or more people associated with the available business resources. The method may also include receiving from the requester, via the graphical user interface, a reservation request for at least one of the available business resources, reserving the at least one available business resource, and providing a visual confirmation of the reservation via the graphical user interface.

In accordance with further aspects of this particular embodiment, the specified business resource criteria may include a requested block of time for a reservation of an available business resource.

In accordance with other aspects of this particular embodiment, the requested block of time for a reservation may be for less than a twenty-four period.

In accordance with further aspects of this particular embodiment, the requested block of time for a reservation may be for at least one of: a day, a week, a month, and a specified range of time less than a year.

In accordance with additional aspects of this particular embodiment, the one or more people associated with the available business resources may include people reserving a business resource at a geographical location of the available business resources during a period of time specified by the requester.

In accordance with additional aspects of this particular embodiment, the one or more people associated with the available business resources may include people reserving a business resource at a geographical location of the available business resources during current period of time.

In accordance with additional aspects of this particular embodiment, the one or more people associated with the available business resources may include people associated with a group of the requester.

In accordance with additional aspects of this particular embodiment, the graphical user interface may display a map of locations of available business resources.

In accordance with additional aspects of this particular embodiment, the graphical user interface may display a floor plan indicating a layout of business resources, wherein the floor plan indicates available and unavailable business resources for at least one location of available business resources.

In accordance with additional aspects of this particular embodiment, the graphical user interface may dynamically update the displayed floor plan to indicate updated available and unavailable business resources based on one or more factors.

In accordance with additional aspects of this particular embodiment, the one or more factors may include a change in the specified business resource criteria.

In accordance with additional aspects of this particular embodiment, the change in the specified business resource criteria may include a change in a requested reservation period received from the requester.

In accordance with additional aspects of this particular embodiment, the change in the specified business resource criteria may include a reservation received from a second requester.

In accordance with additional aspects of this particular embodiment, the change in the specified business resource criteria may include a change in a resource type requested by the requester.

In accordance with additional aspects of this particular embodiment, the resource type may include at least one of a type of workspace, a type of meeting space, a type of event space, a type of collaborative engineering space, a type of retail space, a type of food service space, and a type of product testing space.

In accordance with additional aspects of this particular embodiment, the techniques may further include receiving user profile information from the requester, and providing social networking functionality using the user profile information.

In accordance with additional aspects of this particular embodiment, the user profile information may include one or more of: occupation, education, employer, skills, desired skills, desired resources, age, work address, home address, user location information, a friends list, a co-worker list, a team list, a contacts list, a user picture, contact information, employment history, a resume, endorsements by a user, recommendations of a user, business resource payment information, available business resource quota, used business resource quota, and business resource reservation information.

In accordance with additional aspects of this particular embodiment, the user profile information may include a parameter determining at least one of: user profile privacy, user contact preferences, and marketing preferences.

In accordance with additional aspects of this particular embodiment, the social networking functionality may include at least one of: groups, messaging, a contacts database, shared documents, group scheduling, document sharing, availability indicators, invitations, notifications, electronic introductions, electronic resumes, professional profile posting, professional profile editing, professional profile searching, mailing lists, crowd-sourcing, and resource sharing.

In accordance with additional aspects of this particular embodiment, the techniques may further include displaying via the graphical user interface indications of one or more events associated with a geographical location of the available business resources.

In accordance with additional aspects of this particular embodiment, the one or more events may include at least one of: a social event, a lecture, a training, a certification course, and a business meeting.

In accordance with additional aspects of this particular embodiment, business resources may include at least one of: printing, 3d printer, color printing, personnel, call screening, video conferencing, conference call facilities, whiteboards, office supplies, voicemail, mail boxes, catering, dining facilities, cloud based storage, cloud based backup, a virtual machine, server space, engineering tools, and storage.

In accordance with additional aspects of this particular embodiment, personnel may include at least one of: a receptionist, a secretary, a document processor, and a graphic artist.

In another particular embodiment, the techniques may be realized as an article of manufacture for on demand business resource management. The article of manufacture may include at least one non-transitory processor readable storage medium and instructions stored on the at least one medium. The instructions may be configured to be readable from the at least one medium by at least one processor and thereby cause the at least one processor to operate so as to receive, from a requester, a request via a network for a business resource including at least one of: a workspace, a meeting space, and an event space. The instructions may also be configured to be readable from the at least one medium by at least one processor and thereby cause the at least one processor to operate so as to authenticate the requestor, determine whether one or more available business resources match the request, and provide an interactive graphical user interface indicating available business resources, wherein the interactive graphical user interface is configured to accept parameters specifying business resources criteria and to update the interactive graphical user interface to indicate available business resources meeting the business resource criteria. The instructions may be configured to be readable from the at least one medium by at least one processor and thereby cause the at least one processor to operate so as to display via the graphical user interface indications of one or more people associated with the available business resources, to receive from the requester, via the graphical user interface, a reservation request for at least one of the available business resources, to reserve the at least one available business resource, and to provide a visual confirmation of the reservation via the graphical user interface.

In another particular embodiment, the techniques may be realized as a system for on demand business resource management including one or more processors communicatively coupled to a network. The one or more processors may be configured to receive, from a requester, a request via a network for a business resource including at least one of: a workspace, a meeting space, and an event space, to authenticate the requestor, to determine whether one or more available business resources match the request, and to provide an interactive graphical user interface indicating available business resources, wherein the interactive graphical user interface is configured to accept parameters specifying business resources criteria and to update the interactive graphical user interface to indicate available business resources meeting the business resource criteria. The one or more processors may be configured to display via the graphical user interface indications of one or more people associated with the available business resources, to receive from the requester, via the graphical user interface, a reservation request for at least one of the available business resources, to reserve the at least one available business resource, and to provide a visual confirmation of the reservation via the graphical user interface.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF FIGURES

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows a block diagram depicting a network architecture 100 for on demand business resource management, in accordance with an embodiment of the present disclosure.

FIG. 2 depicts a block diagram of a computer system in accordance with an embodiment of the present disclosure.

FIG. 3 shows a module for on demand business resource management, in accordance with an embodiment of the present disclosure.

FIG. 4 depicts a method for on demand business resource management, in accordance with an embodiment of the present disclosure.

FIG. 5 depicts a method for on demand business resource management enrollment, in accordance with an embodiment of the present disclosure.

FIG. 6 depicts a user interface for on demand business resource management, in accordance with an embodiment of the present disclosure.

FIG. 7 depicts a user interface navigation bar for on demand business resource management, in accordance with an embodiment of the present disclosure.

FIG. 8 depicts a user interface for on demand business resource scheduling, in accordance with an embodiment of the present disclosure.

FIG. 9 depicts a user interface for business social networking, in accordance with an embodiment of the present disclosure.

FIG. 10 depicts a high level view of a user interface for on demand business resource management, in accordance with an embodiment of the present disclosure.

FIGS. 11A-11D depict a user interfaces for on demand business resource management, in accordance with an embodiment of the present disclosure.

FIGS. 12A-12C depict a user interfaces for on demand business resource management, in accordance with an embodiment of the present disclosure.

FIG. 13 depicts a user interface for on demand business resource management, in accordance with an embodiment of the present disclosure.

FIG. 14 depicts a user interface for on demand business resource management, in accordance with an embodiment of the present disclosure.

FIG. 15 depicts a user interface for reserving on demand business resources, in accordance with an embodiment of the present disclosure.

FIG. 16 depicts a user interface for on business networking associated with on-demand business resources, in accordance with an embodiment of the present disclosure.

FIG. 17 depicts a user interface for a confirmation code for on demand business resources, in accordance with an embodiment of the present disclosure.

FIG. 18 depicts a user interface for on business networking associated with on-demand business resources, in accordance with an embodiment of the present disclosure.

### DETAILED DESCRIPTION

Embodiments of the present disclosure leverage technology to match supply of commercial real estate with modern mobile workers. By aggregating real-estate through short-term leases and/or a profit sharing model, embodiments of the present disclosure create a member network of co-working spaces. The technology platform on desktop and mobile devices makes the physical locations accessible and visible. Specifically, embodiments of the present disclosure make it possible for users to view capacity, reserve space and engage with other member users. Thereby embodiments of the present disclosure provide monitoring of member activity to measure capacity, while creating visibility for other members. Embodiments of the present disclosure allow users to digitally manage capacity of any physical space for the purposes of space planning and social/professional connecting, whether within member network or otherwise. Additionally, embodiments of the present disclosure leverage mobile device technology (e.g., via Quick Response (QR) codes or other codes on a user device) to access physical sites, as well as print onsite, to use other resources, to accredit a user's account for on and off site activities, and to purchase within a member network through location devices.

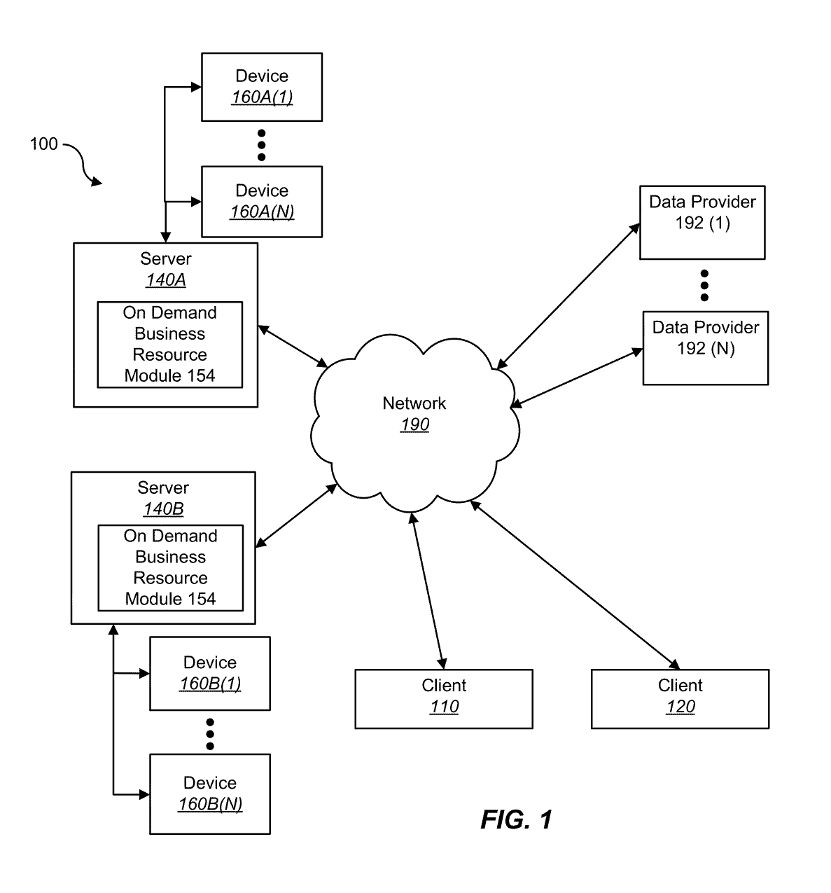

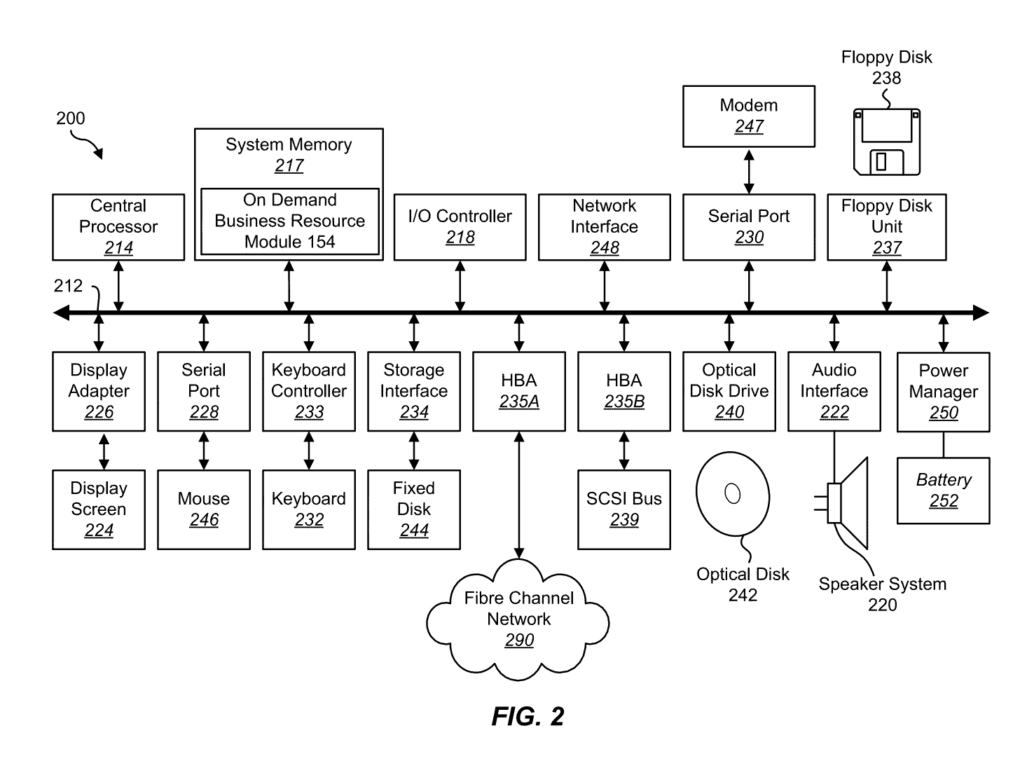

Turning now to the drawings, FIG. 1 shows a block diagram depicting a network architecture 100 for on demand business resource management, in accordance with an embodiment of the present disclosure. FIG. 1 is a simplified view of network architecture 100, which may include additional elements that are not depicted. Network architecture 100 may contain client systems 110 and 120, as well as servers 140A and 140B (one or more of which may be implemented using computer system 200 shown in FIG. 2). Client systems 110 and 120 may be communicatively coupled to a network 190. Server 140A may be communicatively coupled to storage devices 160A(1)-(N), and server 140B may be communicatively coupled to storage devices 160B(1)-(N). Servers 140A and 140B may contain a management module (e.g., on demand business resource management module 154). Data providers 192(1)-(N) may be communicatively coupled to network 190.

With reference to computer system 200 of FIG. 2, modem 247, network interface 248, or some other method may be used to provide connectivity from one or more of client systems 110 and 120 to network 190. Client systems 110 and 120 may be able to access information on server 140A or 140B using, for example, a web browser or other client software (not shown) as a platform. Such a platform may allow client systems 110 and 120 to access data hosted by server 140A or 140B or one of storage devices 160A(1)-(N) and/or 160B(1)-(N).

Network 190 may be a local area network (LAN), a wide area network (WAN), the Internet, a cellular network, a satellite network, or other networks that permit communication between clients 110, 120, servers 140, and other devices communicatively coupled to network 190. Network 190 may further include one, or any number, of the exemplary types of networks mentioned above operating as a stand-alone network or in cooperation with each other. Network 190 may utilize one or more protocols of one or more clients or servers to which they are communicatively coupled. Network 190 may translate to or from other protocols to one or more protocols of network devices. Although network 190 is depicted as one network, it should be appreciated that according to one or more embodiments, network 190 may comprise a plurality of interconnected networks.

Storage devices 160A(1)-(N) and/or 160B(1)-(N) may be network accessible storage and may be local, remote, or a combination thereof to server 140A or 140B. Storage devices 160A(1)-(N) and/or 160B(1)-(N) may utilize a redundant array of inexpensive disks (“RAID”), magnetic tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), optical based storage, or other computer accessible storage. Storage devices 160A(1)-(N) and/or 160B(1)-(N) may be used for backup or archival purposes.

According to some embodiments, clients 110 and 120 may be smartphones, PDAs, tablets, desktop computers, a laptop computers, servers, printing solutions, other computers, or other devices coupled via a wireless or wired connection to network 190. Clients 110 and 120 may receive data from user input, a database, a file, a web service, and/or an application programming interface.

Servers 140A and 140B may be application servers, archival platforms, backup servers, network storage devices, media servers, email servers, document management platforms, enterprise search servers, or other devices communicatively coupled to network 190. Servers 140A and 140B may utilize one of storage devices 160A(1)-(N) and/or 160B(1)-(N) for the storage of application data, backup data, or other data. Servers 140A and 140B may be hosts, such as an application server, which may process data traveling between clients 110 and 120 and a backup platform, a backup process, and/or storage. According to some embodiments, servers 140A and 140B may be platforms used for backing up and/or archiving data. One or more portions of data may be backed up or archived based on a backup policy and/or an archive applied, attributes associated with the data source, space available for backup, space available at the data source, or other factors.

Data providers 192(1)-(N) may provide cloud based storage, online resources, on demand virtual machines, on demand hosting, and other services.

According to some embodiments, clients 120 and 130 may be mobile devices and on demand business resource management module 154 may be implemented on one or more mobile platforms including, but not limited to Android, iOS, WebOS, Windows Mobile, Blackberry OS, and Symbian. On demand business resource management module 154 may be implemented on top of one or more platforms such as, for example, Internet Explorer, FireFox, Chrome, and Safari. In some embodiments, on demand business resource management module 154 may implemented on a desktop client.

On demand business resource management module 154 may allow individuals possessing user client 110 and/or client 120 to locate a specific physical location from an on device map or inputted location. Individuals may then be directed to a location specific digital floor plan and/or digital list of spaces from which to select a designated desk spot or area. Individuals may see what other individuals are on physical location during the desired time as well as see the capacity of individuals on physical location. Individuals will then be able to select and reserve one or more spaces. Client 110 and/or client 120 may be any device capable of communicating with network 106. For example, client 110 and/or client 120 can be a laptop, personal computer, smartphone, tablet.

In some embodiments, on demand business resource management module 154 may provide on demand business resource management including receiving from one or more requesters, a request via a network for a business resource. Business resources may include a workspace, a meeting space, and an event space, or other commercial real estate. On demand business resource management module 154 may authenticate a requestor. Authentication may be via one or more of a user name, a password, a cryptographic key, digital signature, certificate, a CAPTCHA code, biometric authentication, and/or verification of a confirmation code. According to some embodiments, authentication may occur via a unique identifier associated with a mobile device. For example, on demand business resource management module 154 may be a web based application or an application on a mobile device of a user. The user's mobile device may authenticate via a unique identifier (e.g., a phone number, an International mobile subscriber identity (IMSI) number, an International Mobile Station Equipment Identity (IMEI) number, a mobile equipment identifier (MEID), an Electronic serial numbers (ESN), and a Mobile Subscriber Integrated Services Digital Network-Number (MSISDN)). In some embodiments, on demand business resource management module 154 may detect a mobile device (e.g., via blue tooth), recognize the identity of a device (e.g., via membership records or other data records associated with a device identifier), and provide access to a facility. On demand business resource management module 154 may determining whether one or more available business resources match the request and may provide an interactive graphical user interface indicating available business resources. As described in greater detail below, an interactive graphical user interface provided by on demand business resource management module 154 may be configured to accept parameters specifying business resources criteria and to update the interactive graphical user interface to indicate available business resources meeting the business resource criteria. For example, on demand business resource management module 154 may utilize a web based interface and the graphical user interface may display a map of locations of available business resources. According to one or more embodiments, the floor plan may indicate a layout of business resources, and may indicates available and unavailable business resources for at least one location of available business resources.

On demand business resource management module 154 may dynamically update a displayed floor plan to indicate updated available and unavailable business resources based on one or more factors. Exemplary factors may include a change in the specified business resource criteria. For example, if a requestor changes a requested reservation period (e.g., from 10 AM-1 PM of the present day to 11:30 AM-2 PM of the present day) fewer, greater, and/or different resources may be available and a graphical user interface may update accordingly. On demand business resource management module 154 may also dynamically update a user interface to show available resources based on other factors such as, for example, a change in requested resource type (e.g., from a desk to a conference room). Other factors affecting available resource may include a change in location such as, for example, a new location specified by user input or detected based on location information received from a user's mobile device (e.g., GPS based information). Availability may be also dynamically updated by on demand business resource management module 154 based on the activity of other users (e.g., a reservation received from another requester or a workspace being indicated as unavailable for cleaning, repair, or other issues).

On demand business resource management module 154 may show the availability of a plurality of types of business resources including, but not limited to, a workspace, a meeting space, an event space, a collaborative engineering space, a product testing space, and other commercial space. Other business resources managed by on demand business resource management module 154 may include printing, 3d printer, color printing, personnel, call screening, video conferencing, conference call facilities, whiteboards, office supplies, voicemail, mail boxes, coffee, vending, catering, dining facilities, cloud based storage, cloud based backup, virtual machines, server space, engineering tools (e.g., electronics testing equipment, etc.), and/or storage (e.g., lockers, lockboxes). On demand business resource management module 154 may allow the entry of one or more resources (e.g., a workspace with printing, a conference room with video conferencing) and may display the availability of such resources. Other resources may include personnel (e.g., a receptionist, a secretary, a document processor, and a graphic artist). On demand business resource management module 154 may provide intuitive user interface controls that allow a user to dynamically see availability of resources based on criteria. According to some embodiments, available resources may be displayed in near real time as a user inputs criteria such as, for example, a date time range for a requested resource (e.g., from 1-4 pm for a workspace at a particular location). A user may change a slider, a drop down selection, a radio button, a dial or other user interface control and view dynamic updates to available resources. On demand business resource management module 154 may also provide hours, directions, rates, and access information for one or more facilities.

In addition to managing utilization of business resources, in some embodiments, other types of resources may be managed. For example, a gym may sell hours of time and may track and/or reserve utilization of the gym by one or more member. Reservations may be for entrance to a gym, for use of a particular resource or piece of equipment (e.g., a type of machine, a particular machine, a classroom, a pool), or an event (e.g., a class or a private lesson or training) A member may schedule or reserve time. A member may also see who will be at a facility at a particular time or find a facility with a lower number of reservations.

On demand business resource management module 154 may allow a user to schedule one or more resources. A display of available resources may be updated dynamically to reflect that a resource is no longer available once a user has scheduled it. According to some embodiments, color codes or other indicators may be used (e.g., green for available and red for unavailable). Other schemes and indicators may be utilized. For example, a different indicator and/or color may be used to indicate a resource reserved by the user viewing the interface. According to some embodiments, on demand business resource management module 154 may verify an account balance, user credits, payment terms, or other financial information prior to scheduling or reserving a resource. On demand business resource management module 154 may allow a user to schedule block of time for a reservation is for less than a twenty-four period. On demand business resource management module 154 may also allow a user to schedule a requested block of time for a reservation that is for at least one of: a day, a week, a month, and a specified range of time less than a year. Information about reserved resources may be displayed based on user preferences, administrator preferences, or other factors. Reservations may confirm a cost or use of credits with a user. The rate of a business resource may depend on the type of resource (e.g., workspace, private office, conference room, etc.), the location of a resource, the length of a reservation for a resource, a user membership type, and other factors (e.g., discounts for off-peak times, special offers, loyalty rewards, etc.). Resource rates may also depend on a size of the resource. For example, a rate for a larger conference room may be higher than a rate for a smaller conference room. According to some embodiments, a user may schedule resources as needed and/or as available by using a console at a facility (e.g., walking in and scheduling a few hours for that particular day). A user may also schedule resources in advance and reserve specified resources. In some embodiments a user may pay for a block of time as they schedule it. In one or more embodiments, a user may purchase blocks of time in advance and may later schedule blocks of time debited against the user's account. For example, a user may purchase a plan providing a credit for a specified amount of time (e.g., 8 hours, 20 hours, or 50 hours). According to some embodiments, unused time may be exchanged or transferred by a user. Time credited to a group may allow a group to pool or share hours. For example, a user may transfer time to another user (as a gift or in exchange for payment or other resource credits such as printing or conference room time), credit time to a group, or exchange time for other credits. Other credits for which resource time may be exchanged may include credits for many other resources including, for example, printing, office supplies, secretarial assistance, reception assistance, computer and device troubleshooting assistance, computer and device repair and support, office supplies, concierge services, and catering. In some embodiments in which purchased hours may expire, a user may be able to suspend a plan (e.g., due to out of the country travel, etc.) which may prevent expiration of hours.

In some embodiments, membership in a business resource sharing organization may provide loyalty rewards, discounts, and/or other benefits. For example, a user may be provided, via an application on their mobile device, with information about discounts at one or more partners near a resource sharing facility or a current location of a user (e.g., discounts at a coffee shop, wine store, restaurant, market, theater, sporting facility, etc.). A user may be provided with directions and information about partners, products, services, and related discounts. A user may be provided with a QR code or other confirmation code which may allow them to sign in at a partner location to receive a discount (e.g., at a checkout of a coffee shop). In some, embodiments, an application on a mobile device of a user may show partner locations on a map. A mobile application may allow a user to make payments to a business resource sharing organization, to a partner, and/or to another user. A mobile application may allow a user to input account information or a user may specify an account associated with a business resource sharing organization. Users may also be able to pay for or receive payment from other members (e.g., a user may purchase hours for another member in their group, company, or other organization). A mobile application may also allow a user to view, redeem, and/or transfer rewards. For example, a user may earn points based on purchased hours or other services. In some embodiments, a user may redeem points for additional hours, services, or for goods or services at a partner location (e.g., coffee, meals, etc.). Purchases at partner locations may also accrue rewards that may be redeemable for one or more goods or services at a business resource sharing organization (e.g., purchase of meals at a partner location may earn points redeemable for hours at a resource sharing facility.) In some embodiments, a business resource sharing organization may allow a user with accounts to pay or receive payment to/from other users with accounts at the business resource sharing organization (e.g., the business resource sharing organization may operate as a broker of services between members). A user may also use a mobile application to share, sell, or purchase hours, services, or goods from other users.

According to some embodiments a user may join a business resource sharing organization for business and or social networking and may not reserve space. For example, a user may join to participate in social connections and to attend events. A user may also host events at common spaces according to some embodiments (e.g., product demonstrations, networking events, recruiting events). Such events may or may not require payment by a host and may be sponsored by a facility to increase demand and attendance at a facility. Admission to events, payment for events, attendance tracking at events, and/or other event management functionality may be facilitated by a use of QR codes, mobile device identifiers, confirmation codes, or other identifiers. For example, a user may use a QR code to sign in or unlock a door to attend an event. In some embodiments, a registered mobile device of a user may be detected (e.g., via WiFi or blue tooth) and such detection may unlock a door and/or register a user for an event. For example, a user may receive a QR code from another group member for an event via a mobile application (e.g., an organization may purchase QR codes for employees and may use an application of a business resource sharing organization to pay for admission and to distribute the QR codes).

In one or more embodiments, on demand business resource management module 154 may display via a graphical user interface, indications of one or more people associated with the available business resources. For example, the one or more people associated with the available business resources comprise people reserving a business resource at a geographical location of the available business resources during a period of time specified by the requester. For example, a requester may see a list of people who are at a particular location providing on-demand workspace during a period of time the requester is reserving space at that location. The list of people may include, for example, people associated with a group of the requester, co-workers of a user, contacts of a user, or based on other affiliations (e.g., occupation type, skill set, etc.). In some embodiments, users may be displayed simply based on their reservation of business resources (e.g., work space) during a period of time that a user has indicated interest in reserving. Displayed user information may be based on user preferences (e.g., privacy controls), administrator preferences, or other factors. User information may be displayed for a particular location a requestor has reserved time for or for a plurality of locations. For example, a requester may see who is scheduled to be at a particular location during his reserved time or at all locations.

In some embodiments, a user may view who is using a particular resource (e.g., a workspace or conference room). For example, a conference room may be reserved and a user may determine that it is being reserved by a member of a group that a user belongs to. The user may contact the group member and ask to share the resource. If agreed to by both parties, a reservation may be shared and may be billed accordingly. In some embodiments, on demand business resource management module 154 may facilitate the reservation of adjacent space for a group (e.g., identifying blocks of adjacent workspace for reservation, or indicating reservations of a group by color coding). In some embodiments, on demand business resource management module 154 may facilitate scheduling concurrent blocks of time at different workspaces (e.g., via group calendar regardless of whether or not the group is at a same location). In one or more embodiments, on demand business resource management module 154 may provide different rates for group reservations. According to some embodiments, on demand business resource management module 154 may provide a user interface showing available timeslots and groups of resources (e.g., adjacent workspaces) for a block of users. For example, a user may specify a location and a number of a type of resources for a particular location and date. A block or group reservation may be made several different ways. For example, a user may pay for or use an account to cover the entire block reservation. A user may also reserve their space and tentatively reserve the other spaces. Invitations or notifications may be sent to other specified users for the other spaces. If a user accepts an invitation the corresponding space may be reserved and that user may be charged for the space. For example, a user may specify the desired number of spaces to tentatively reserve by clicking on contacts in a social networking interface of on demand business resource management module 154.

According to some embodiments, business resources, a facility, or a portion of a facility may be facilitated with an enterprise. For example, a corporation may purchase blocks of time and/or reserve resources at a facility for its employees, consultants, or for other reasons. A corporation may purchase blocks of time for use at a facility in a region in which they do not have permanent office space, a region in which they need extra office space, a region in which they have a project, or for other reasons. In some embodiments, certain space in a facility may be reserved (e.g., temporarily or on a longer term basis) for a specific enterprise and employees of that enterprise may reserve the space. In other embodiments, an enterprise may purchase credits for hours of resource use, but reservation of space may depend on availability. According to at least one embodiment, users associated with an enterprise may have priority in reserving resources (e.g., they may be able to bump a non-enterprise user from certain resources, or non-enterprise users may have access to a resource only after it is confirmed that an enterprise user is not using the resource at the desired time period).

In one or more embodiments, in addition to providing on-demand resource management by buying a facility or leasing a facility long-term and then sharing it via short-term leases (e.g., hourly) as described herein, other on-demand resource management may be provided. For example, a large corporate or government entity may provide on-demand business resources to allow use of their excess capacity. As a further example, a hotel or government organization may hire a branded on-demand resource management organization to utilize excess capacity (e.g., conference rooms, office space, etc.). Such an embodiment may include an office or kiosk on-site at a hotel or other organization which may allow access to resources for both the organization's members (e.g., hotel guests or government employees) as well as other individuals purchasing time via the on-demand business resource organization. In some embodiments, an organizations members may be given preference (e.g., a certain amount of space may be reserved for hotel guests which may be gradually made available to non-members as it comes closer to the actual period or hour of a potential reservation). In some embodiments, on-demand resource management may be branded under a hotel or government organization brand; in other embodiments, on-demand resource management may be a separate brand (e.g., associated with an on-demand business resource management company).

On demand business resource management module 154 may receiving user profile information from a user and may use this profile information to provide social networking functionality. User profile information may comprises one or more of: occupation, education, employer, skills, desired skills, desired resources, age, work address, home address, user location information, a friends list, a co-worker list, a team list, a contacts list, a user picture, contact information, employment history, a resume, endorsements by a user, recommendations of a user, business resource payment information, available business resource quota, used business resource quota, and business resource reservation information. On demand business resource management module 154 may provide a user interface allowing the entry of user profile privacy parameters, user contact preferences, marketing preferences, and other parameters. Social networking functionality provided by on demand business resource management module 154 may include, but is not limited to groups, messaging, a contacts database, shared documents, group scheduling, document sharing, availability indicators, invitations, notifications, electronic introductions, electronic resumes, professional profile posting, professional profile editing, professional profile searching, mailing lists, crowd-sourcing, and resource sharing.

On demand business resource management module 154 may also provide a user interface displaying indications of one or more events associated with a geographical location of the available business resources. Events may include, for example, social events (meals, happy hours, networking events), lectures, trainings, certification courses, recruiting events, product demonstrations, and business meetings.

Once a user has reserved a resource, on demand business resource management module 154 may monitor usage. For example, a user may scan in when they arrive at location where they have reserved a workspace, a conference room or other business resources. Scanning or checking in may be performed at an entrance to a business resource location, at a front desk of a business resource location, at a workspace of a business resource location, or other onsite locations. Scanning in or checking in may be performed by one or more methods including via a user's mobile device. A user may use a specialized application on their mobile device. A user may provide a Quick Response (QR) Code, a barcode, a confirmation code, a password, or another confirmation code to scan or check in. A QR code or other confirmation code may be entered into a device associated with the business resource location (e.g., a console or scanner at a door or front desk). A user may also provide a confirmation code to a device at a business resource location via user input, blue tooth, WiFi, or other methods. Once scanned in or checked in a user's account may be debited for usage of the reserved asset. Charges may accrue until a user checks out, based on other usage indicators, based on a reservation for a resource, or on other factors. For example, a user may be charged or their account may be debited when checking in for a full amount of reserved time for a workspace (e.g., four hours). In some embodiments, a user may be credited if they check out, scan out, or sign out early. On demand business resource management module 154 may monitor usage via one or more methods. For example, WiFi use or other network use may be associated with an account. Printing may be associated with an account. Video conferencing use, conference call use, or other access to network based resources may be also associated with an account. On demand business resource management module 154 may prompt a user to extend a reservation, inform a user that they may face additional charges, log a user off of networked resources, or take other actions if use of a networked resource is detected beyond a reserved period. In some embodiments, on demand business resource management module 154 may request that a user check out after a reservation period (e.g., via a user interface, via a text message, an email message, or other electronic communication). A user may also have pre-authorized charges for overages (e.g., as part of a contract) and on demand business resource management module 154 may debit a user's account automatically based on detected usage or failure to check out.

On demand business resource management module 154 may provide a user interface allowing a user to view an account, a quota, credits, charges, and other information. Credits and/or charges may be different for different resources. For example, a user may have a quota for printing, a separate quota for conference room use, another quota for workspace use etc. In some embodiments, a user may have a single level of credits, but a rate may be different based on resource type. Quota information may include information about purchasing a block of time for a current day, for a specified future period, or for an unspecified date (e.g., a block of hours credited to a user or group account for future use). A user interface for a group account may be different based upon a level of authority in a group (e.g., administrator, user, etc.) A group account may allow for pooling of group hours to be shared among multiple users.

FIG. 2 depicts a block diagram of a computer system 200 in accordance with an embodiment of the present disclosure. Computer system 200 is suitable for implementing techniques in accordance with the present disclosure. Computer system 200 may include a bus 212 which may interconnect major subsystems of computer system 210, such as a central processor 214, a system memory 217 (e.g. RAM (Random Access Memory), ROM (Read Only Memory), flash RAM, or the like), an Input/Output (I/O) controller 218, an external audio device, such as a speaker system 220 via an audio output interface 222, an external device, such as a display screen 224 via display adapter 226, serial ports 228 and 230, a keyboard 232 (interfaced via a keyboard controller 233), a storage interface 234, a floppy disk drive 237 operative to receive a floppy disk 238, a host bus adapter (HBA) interface card 235A operative to connect with a Fibre Channel network 290, a host bus adapter (HBA) interface card 235B operative to connect to a SCSI bus 239, and an optical disk drive 240 operative to receive an optical disk 242. Also included may be a mouse 246 (or other point-and-click device, coupled to bus 212 via serial port 228), a modem 247 (coupled to bus 212 via serial port 230), network interface 248 (coupled directly to bus 212), power manager 250, and battery 252.

Bus 212 allows data communication between central processor 214 and system memory 217, which may include read-only memory (ROM) or flash memory (neither shown), and random access memory (RAM) (not shown), as previously noted. The RAM is may be the main memory into which the operating system and application programs may be loaded. The ROM or flash memory can contain, among other code, the Basic Input-Output system (BIOS) which controls basic hardware operation such as the interaction with peripheral components. Applications resident with computer system 210 may be stored on and accessed via a computer readable medium, such as a hard disk drive (e.g., fixed disk 244), an optical drive (e.g., optical drive 240), a floppy disk unit 237, or other storage medium. For example, on demand business resource management module 154 may be resident in system memory 217.

Storage interface 234, as with the other storage interfaces of computer system 210, can connect to a standard computer readable medium for storage and/or retrieval of information, such as a fixed disk drive 244. Fixed disk drive 244 may be a part of computer system 210 or may be separate and accessed through other interface systems. Modem 247 may provide a direct connection to a remote server via a telephone link or to the Internet via an internet service provider (ISP). Network interface 248 may provide a direct connection to a remote server via a direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. The devices and subsystems can be interconnected in different ways from that shown in FIG. 2. Code to implement the present disclosure may be stored in computer-readable storage media such as one or more of system memory 217, fixed disk 244, optical disk 242, or floppy disk 238. Code to implement the present disclosure may also be received via one or more interfaces and stored in memory. The operating system provided on computer system 210 may be MS-DOS®, MS-WINDOWS®, OS/2®, OS X®, UNIX®, Linux®, or another known operating system.

Power manager 250 may monitor a power level of battery 252. Power manager 250 may provide one or more APIs (Application Programming Interfaces) to allow determination of a power level, of a time window remaining prior to shutdown of computer system 200, a power consumption rate, an indicator of whether computer system is on mains (e.g., AC Power) or battery power, and other power related information. According to some embodiments, APIs of power manager 250 may be accessible remotely (e.g., accessible to a remote backup management module via a network connection). According to some embodiments, battery 252 may be an Uninterruptable Power Supply (UPS) located either local to or remote from computer system 200. In such embodiments, power manager 250 may provide information about a power level of an UPS.

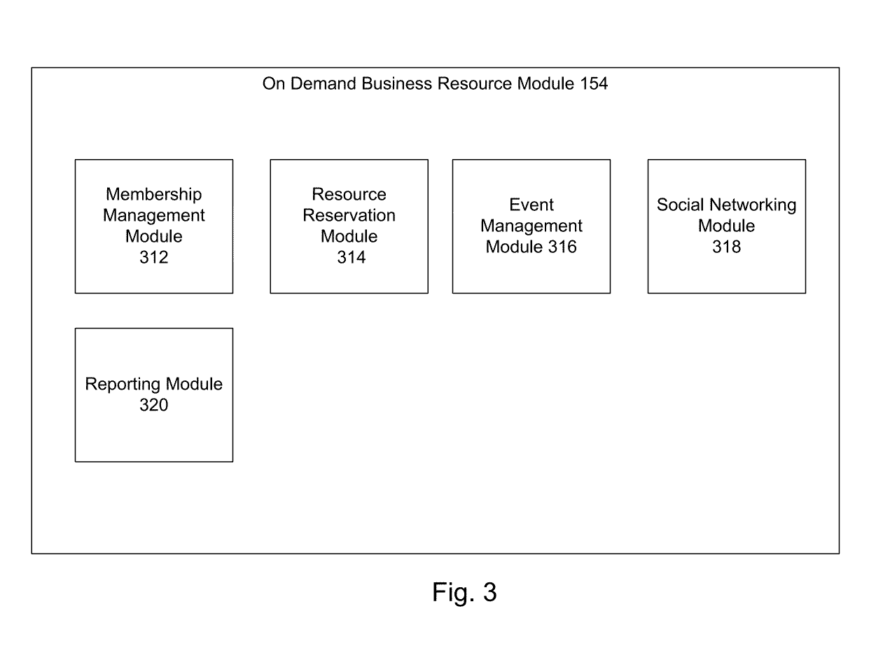

Referring to FIG. 3, there is shown a on demand business resource management module 154 in accordance with an embodiment of the present disclosure. As illustrated, the on demand business resource management module 154 may contain one or more components including membership management module 312, resource reservation module 314, event management module 316, social networking module 318, and reporting module 320.

The description below describes network elements, computers, and/or components of a system and method for improving on demand business resource management that may include one or more modules. As used herein, the term “module” may be understood to refer to computing software, firmware, hardware, and/or various combinations thereof. Modules, however, are not to be interpreted as software which is not implemented on hardware, firmware, or recorded on a processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

Membership management module 312 may provide functionality and/or a user interface for user account management and billing. Membership management module 312 may provide a user interface and functionality for account creation, configuration, and expiration. Membership management module 312 may provide functionality for authentication, check in and check out functionality, QR code generation, confirmation code generation, account monitoring, a user interface for account management and quota visualization and other functionality. A user interface may be available in one or more formats and for one or more platforms (e.g., graphical, list based, command line, speech recognition driven, etc.).

Resource reservation module 314 may provide a user interface allowing visibility of resource availability. A user interface may be available in one or more formats and for one or more platforms (e.g., graphical, list based, command line, speech recognition driven, etc.). Visibility of available resources may be limited based on whether a user is a member, a type of membership (e.g., national, regional, local, preferred, gold member, etc.), and other factors. Resource reservation module 314 may allow a user to select a location via a list, a map interface, or other user interface controls. Resource reservation module 314 may also provide a user with information about facilities and business resources based on a user specified location, based on location information preferences, or based on location information received from a device of a user (e.g., GPS information from a user's smart phone or tablet.) Resource reservation module 314 may provide a floor plan or other graphical user interface indicating available and reserved resources for a specified time period. A user may input one or more criteria and the availability of resources may be dynamically updated in the user interface. For example, if a user changes a time or date of a reservation or changes a type of resource requested, the availability of resources may change accordingly. Resource reservation module 314 may provide hints, indicators of factors affecting resource availability, or recommendations (e.g., your selected reservation extends beyond facility hours, conference rooms close at 7 pm, the downtown facility on smith street is open earlier). Resource reservation module 314 may allow a user to reserve a resource such as, for example, a workspace, based on user authentication, user account approval, availability, and/or other factors. Resource reservation module 314 may provide a confirmation of a reservation to a user, notifications of a reservation to member's group (e.g., based on user preferences), reminders of an upcoming reservation, confirmation of a bill for a completed reservation, directions to a facility, directions to a workspace within a facility, news about a facility (e.g., weather, traffic, or other events affecting a facility), cancellation information (based on a user initiated cancellation, based on a facility mechanical problem, a network outage, or other conditions), and other services.

Event management module 316 may provide indications of one or more events associated with a facility. Events may include, for example, social events (meals, happy hours, networking events), lectures, trainings, certification courses, recruiting events, product demonstrations, sales events, and business meetings. Events may be open to all users of a facility, to members of a group, based on invitation, or based on other criteria. Events may be sponsored by a facility or a user of a facility or events may require a fee from attendees.

Social networking module 318 may provide a user interface and functionality for creating and managing a profile. A user interface may be available in one or more formats and for one or more platforms (e.g., graphical, list based, command line, speech recognition driven, etc.). User profile information may comprises one or more of: occupation, education, employer, skills, desired skills, desired resources, age, work address, home address, user location information, a friends list, a co-worker list, a team list, a contacts list, a user picture, contact information, employment history, a resume, endorsements by a user, recommendations of a user, business resource payment information, available business resource quota, used business resource quota, and business resource reservation information. Social networking module 318 may provide a user interface allowing the entry of user profile privacy parameters, user contact preferences, marketing preferences, and other parameters. Social networking module 318 may provide a user interface and functionality for one or more social networking features including, but not limited to groups, messaging, a contacts database, shared documents, group scheduling, document sharing, availability indicators, invitations, notifications, electronic introductions, electronic resumes, professional profile posting, professional profile editing, professional profile searching, mailing lists, crowd-sourcing, and resource sharing.

Reporting module 320 may provide one or more reports for users of business resource facilities, administrators and others. Reports may include for example, quota usage, printing quota information, workspace quota information, conference room quota information, scheduled reservations, business resource utilization statistics, outages, membership statistics, cloud based storage utilization, WiFi utilization, other resource utilization (e.g., catering, use of virtual machine server space, storage rental, catering, etc.).

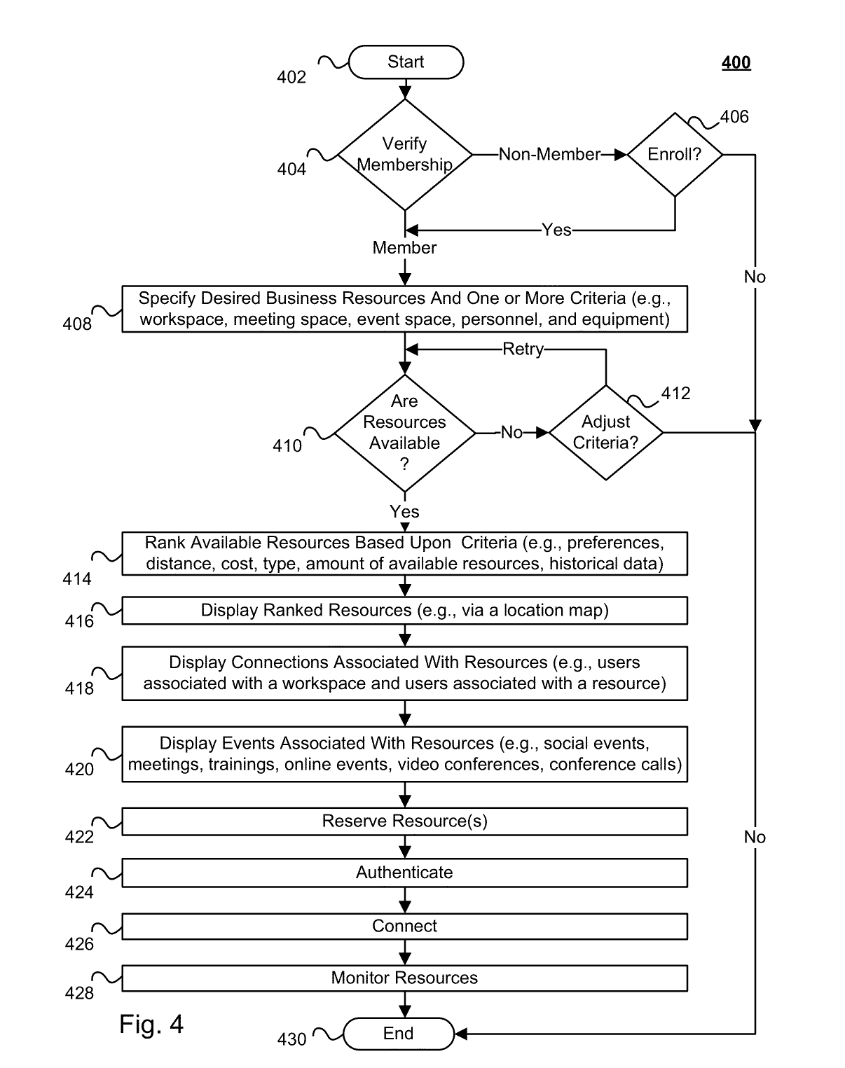

FIG. 4 depicts a method for on demand business resource management, in accordance with an embodiment of the present disclosure. At block 402, the method 400 may start. At block 404, membership may be verified and/or authenticated (e.g., via a website or a mobile device application). If a member is authenticated the method may continue at block 408. If a user is not authenticated, at block 406 a user interface may be presented allowing the user to enroll. Enrollment may include a credit check, entry of user information, preferences, and other factors. If a user enrolls the method may continue at block 408. If a user does not enroll or enrollment is not approved, the method may end at block 430.

At block 408, a user may specify desired business resources and one or more criteria. For example, a user may view a user interface providing a list of locations on a map, a list, or another display. According to some embodiments, a user may listen to a listing of available resources. This list of locations provided may vary based on input from a user such as, for example, a user's current location, a user's expected location at a future date, a desired workspace type, and other factors.

At block 410, the method may query available resources based on user input. If resources are available the method may continue at block 414. If resources are not available the method may continue at block 412. At block 412, a user may adjust criteria if no workspaces are available. For example, a user may try a different location if no conference rooms are available at a particular location at a particular time. A user may also adjust a time or date criteria specified. If a user adjusts criteria the method may search again at block 410. If a user does not adjust criteria the method may end at block 430. According to some embodiments, a user may be put on a waitlist for a particular resource or a resource type within a specified date and time range (e.g., a user may be notified if a conference room becomes available for a particular location on a particular morning).

At block 414 available resources may be ranked based upon one or more criteria (e.g., preferences, distance from a user, cost, type, amount of available resources at a location, historical user preferences, members of a group at a location at that time, etc.).

At block 416 available resources may be presented to a user. For example, a graphical user interface may depict a facility floor plan with indications of available and reserved resources (e.g., workspaces, conference rooms, etc.). According to some embodiments, a map with locations of facilities may be shown and the facilities may contain color codes, mouse over pop-ups, or other indicators of available resources. Clicking of a location may drill down to display a floor plan. According to some embodiments, a user interface may provide a list, a command line interface, or a speech recognition driven interface.

At block 418, a user interface may display people associated with resources at a facility. For example, a user may be able to click on a reserved resource or mouse over a reserved resource and determine who has reserved it. A user may also see a list of connections or people at a facility during the user's reservation time. Display of user information may be controlled by user profile settings, administrator settings, group membership, and/or other factors. For example, a floor plan showing available resources may also display a list of users associated with the reserved spots.

At block 420, events associated with a resource location may be displayed. For example, prior to reserving a user may be able to see events occurring at a facility during a specified time period. Events may be updated based on a day, time, week, month or other period of time indicated by a user. Event visibility may be determined by other factors (e.g., profile preferences, profile connections, group membership, event type, etc.).

At block 422 at user may reserve a resource. Reservation may be done online including, for example via a user's computer, via a user's mobile device, or at a console at a business resource facility. Reservation may include verification of user account information, verification of sufficient resources, user confirmation, and other processing. According to some embodiments, a user may select one or more desired resource types and a matching or recommendation algorithm may recommend a resource. For example, a user may specify a desired workspace type and time and a matching algorithm may identify an available workspace to recommend to the user based on one or more factors. Factors may include, for example, social and business networking opportunities based on the users profile and the proximity of the recommended space to reserved spaces of other user's with business compatible profiles. Business compatible profiles may include users with a same or similar occupation, complimentary occupations, similar skill sets, complimentary skill sets, shared connections, shared interests, or other points of common interest. According to some embodiments, a user making a reservation may provide an indication of one or more skill sets, occupations, or factors they are interested in (e.g., Java software development, investment counseling, product marketing, etc.).

At block 424 at user may arrive at a business resource facility and may authenticate. For example, a user may scan in when they arrive at location where they have reserved a workspace, a conference room or other business resources. Scanning or checking in may be performed at an entrance to a business resource location, at a front desk of a business resource location, at a workspace of a business resource location, or other onsite locations. Scanning in or checking in may be performed by one or more methods including via a user's mobile device. A user may use a specialized application on their mobile device. A user may provide a Quick Response (QR) Code, a barcode, a confirmation code, a password, or another confirmation code to scan or check in. A QR code or other confirmation code may be entered into a device associated with the business resource location (e.g., a console or scanner at a door or front desk). A user may also provide a confirmation code to a device at a business resource location via user input, blue tooth, WiFi, or other methods. Once scanned in or checked in a user's account may be debited for usage of the reserved asset. A user may be provided with directions to a reserved resource within the facility and information about the reserved workspace. A user may also be provided with other instructions or directions via a printout or communication to a user device (e.g., via a mobile application, a text message, an email, etc.). Other directions may include information on contracts, rules, guidelines, support information, and information on accessing addition al resources (vending, conference services, IT support, etc.). In some embodiments, an application interface providing support may allow a user to locate and/or contact a nearest available support personnel. Contact may include messaging, emailing, calling, and/or video conferencing with a support personnel.

At block 426, a user may connect to one or more resources at a facility (e.g., WiFi, Ethernet, cloud based resources, wireless printing, etc.). A user may access automated supplies and services at a facility (e.g., a vending machine for office supplies may accept traditional payment methods, QR codes, or other confirmation codes). A user may also may social and/or business connections. A user may login to an application or website providing social networking resources such as information about current users sharing a facility or online at other associated facilities. Electronic introductions, messaging, file sharing, and electronic collaborative workspace may be provided. According to some embodiments, recommended connections may be provided based on occupation, skills, preferences, shared connections, employer, user availability (e.g., available or do not disturb indicators set on a user profile), user reservation history (e.g., previously reserved adjacent space, member of the same group) and/or other factors.

At block 428, resource usage may be monitored and billed accordingly. At block 430, the method may end.

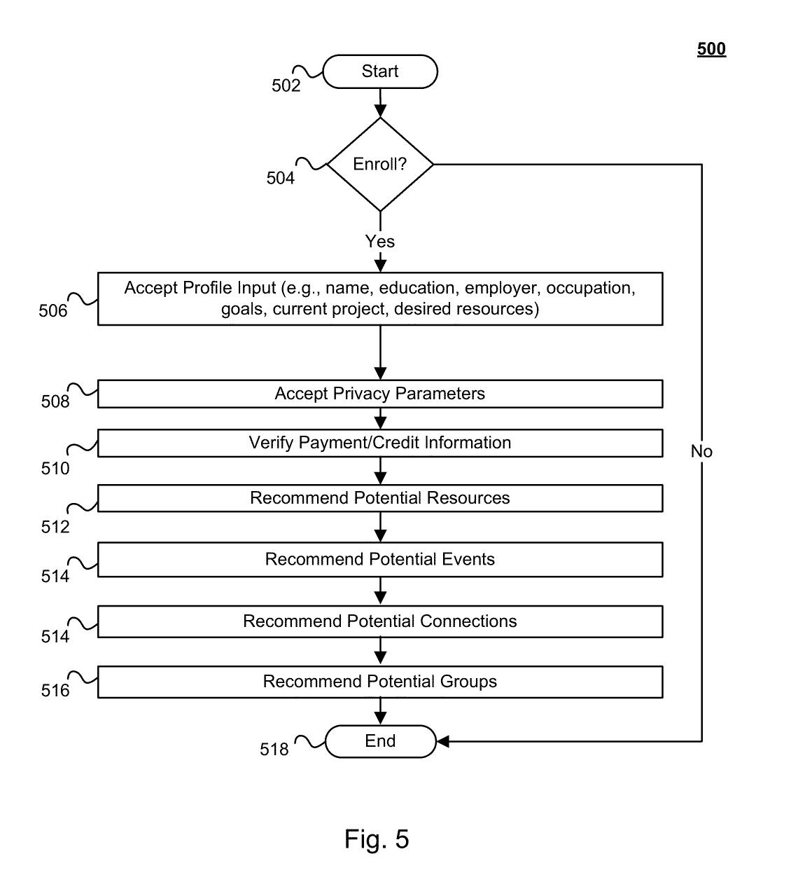

FIG. 5 depicts a method for on demand business resource management enrollment, in accordance with an embodiment of the present disclosure. At block 502, the method 500 may begin. At block 504, the method may confirm whether or not a user wishes to enroll in a business resource sharing plan. If a user desires to enroll, the method may continue at block 506. If a user does not wish to enroll the method may end at block 516.

At block 506, a user may enter profile information (e.g., name, address, education, occupation, employer, goals, current project, desired resources, contact information, etc.).

At block 508 privacy parameters may be entered. Privacy parameters may determine a user's visibility online via one or more social networking applications.

At block 510 potential resources may be recommended to a user. Recommendations may be based on specified user preferences, on a current user location, or based on other factors. For example, a workspace may be recommended to a user based on an occupation in common with a frequent occupant of an adjoining workspace.

At block 512 potential events of interest may be recommended to a user. Events may include, for example, social events (meals, happy hours, networking events), lectures, trainings, certification courses, and business meetings. Events may be open to all users of a facility, to members of a group, based on invitation, or based on other criteria. Events may be sponsored by a facility or a user of a facility or events may require a fee from attendees.

At block 514 potential connections may be recommended to a user. Connections may be for example, individuals who share an occupation, a skill set, an interest, a common group, or a common connection (e.g., a friend of both parties). Connections may also be individuals possessing a desired skill set for a project of a user (e.g., a technical expertise for a software related project specified in a user profile or a financial expertise for a business project of a group of a user).

At block 516 potential groups of interest may be recommended to a user. Groups may be related to social interests and/or business interests.

At block 518 the method 500 may end.

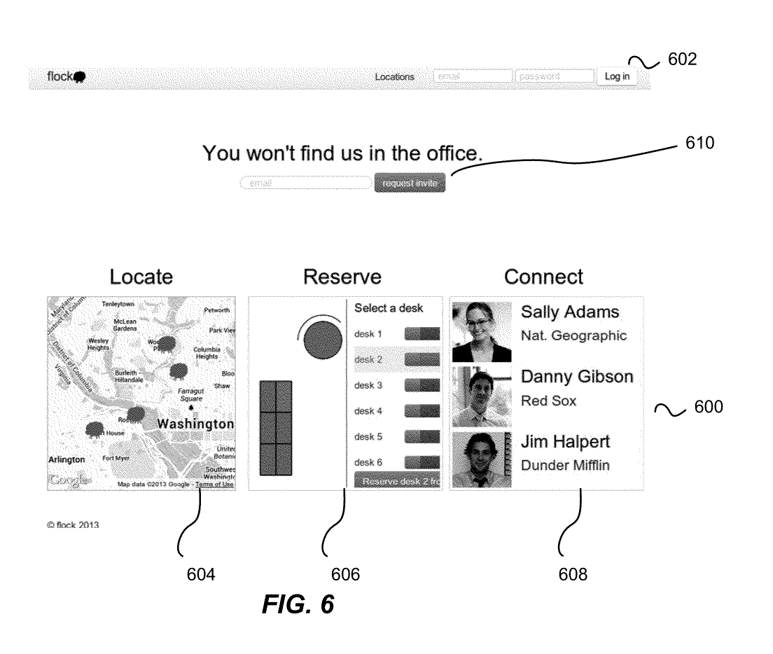

FIG. 6 depicts a user interface for on demand business resource management, in accordance with an embodiment of the present disclosure. User interface 600 may be a welcome page for a user interface allowing on-demand business resource scheduling and other services. User interface 600 may be a welcome and/or promotional screen for a business resource sharing organization. User interface control 610 may be a submit button allowing a user to provide an email address for further information. User interface control 604 may be an interactive map displaying a location of one or more business resource facilities. User interface control 606 may be an advertisement for business resource reservations and/or may provide limited or full visibility into available resources and reservations (e.g., user interface control 606 may be a screen capture or may provide visibility into available resources without an ability to reserve resources). User interface control 608 may provide a screen capture depicting social networking functionality of a business resource sharing user interface. User interface control 602 may allow a user login to access full functionality.

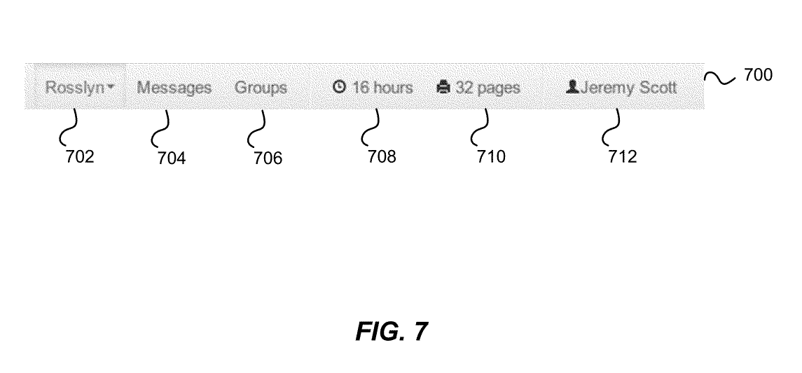

FIG. 7 depicts a user interface navigation bar 700 for on demand business resource management, in accordance with an embodiment of the present disclosure. According to some embodiments, user interface navigation bar 700 may be a widget, component, a toolbar, or browser add-on. According to some embodiments, user interface navigation bar 700 may be an application for a computer or a mobile device (e.g., downloadable from an App store, Google Play, etc.) User interface navigation bar 700 may provide user interface control 702 allowing a user to select a location, user interface control 704 providing access to electronic messages, user interface control 706 providing access to groups, user interface control 708 showing a user quota (e.g., for workspaces), user interface control 710 showing a user quota for printing, and user interface control 712 showing login information. Other user interface controls may be added. User interface controls may also be deleted, hidden, or removed from user interface navigation bar 700.

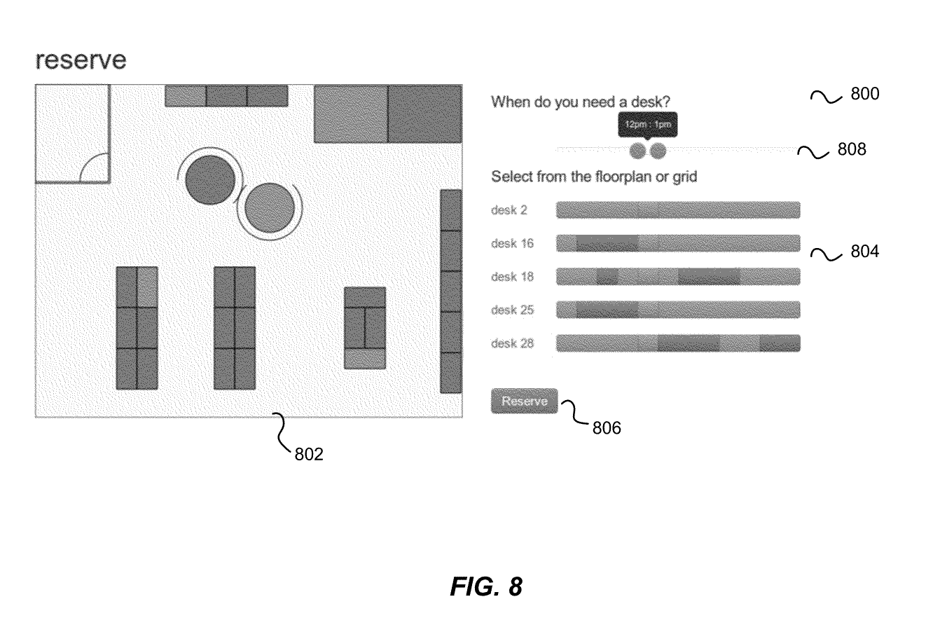

FIG. 8 depicts a user interface for on demand business resource scheduling, in accordance with an embodiment of the present disclosure. User reservation interface 800 may display interactive floor plan 802 and interactive time grid 804. User reservation time input 808 may be a slider allowing a user to specify a starting time and an ending time for a specified date. Other controls may be used (e.g., spinners, text boxes, etc.). According to some embodiments, starting times and ending times may be limited based on facility hours for a currently selected facility, a currently selected date, and other factors. Adjusting user reservation time input 808 may dynamically update interactive floor plan 802 and/or interactive time grid 804. For example, if a longer desired reservation time is specified more resources (e.g., workspaces) may be indicated as unavailable. Availability may be indicated by color coding (e.g., red for unavailable spaces and green for available spaces), by patterns, by textual indicators, or by other methods. Interactive time grid 804 may also update by showing portions of a time span that a particular resource (e.g., desk 2, desk 16, desk 18, desk 25, and desk 28) are available. For example, color coding on a bar next to a desk may indication which portions of a time grid a desk is available (e.g., coded as green) and which a desk in unavailable (e.g., coded as red). According to some embodiments, if a resource is unavailable for the entire timespan it may not appear on Interactive time grid 804. For example, if a user adjusts user reservation time input 808 to specify only from 1 p.m. to 2 p.m., desk 28, which is unavailable during that time period, may not appear on Interactive time grid 804. Adjusting user reservation time input 808 to specify a longer period of time may make more resources appear on Interactive time grid 804. Once a user has identified a resource they want to reserve they may click on the item on the interactive floor plan 802. Interactive floor plan 802 may update to indicate a focus on a selected resource. The user may then click on reserve button 806. Interactive floor plan 802 and/or interactive time grid 804 may be updated to provide confirmation of the reservation. Other confirmation indications may be provided.

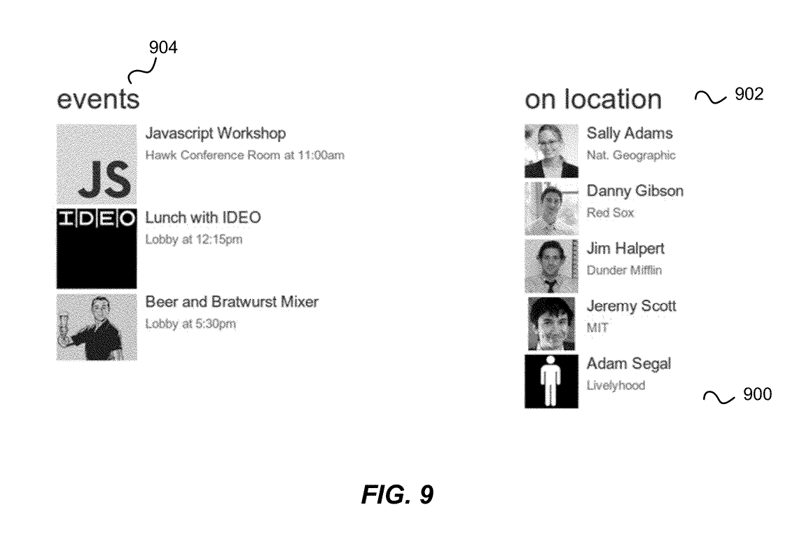

FIG. 9 depicts a user interface for business social networking, in accordance with an embodiment of the present disclosure. User interface 900 may provide events display interface 904 and connections display interface 902. Events display interface 904 may display events for a current location. Events may be events at a business resource location for a current day of a reservation or prospective reservation, a current period of a reservation, or for other periods (e.g., during the week of a reservation). Clicking on an event may provide more information (e.g., attendees, invitation information, cost, etc.). Connections display interface 902 may provide a list of people currently at a business resource location. Clicking on a person may provide more information, an invitation to connect, and/or other social networking functionality (e.g., an interface to send a message to that person).

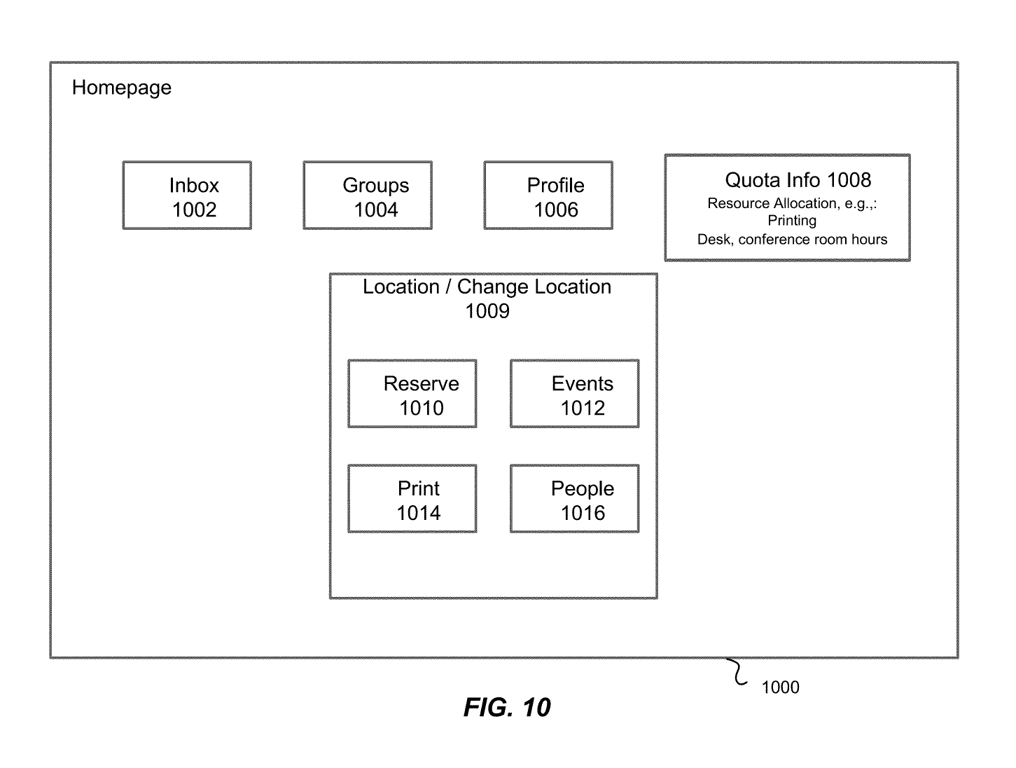

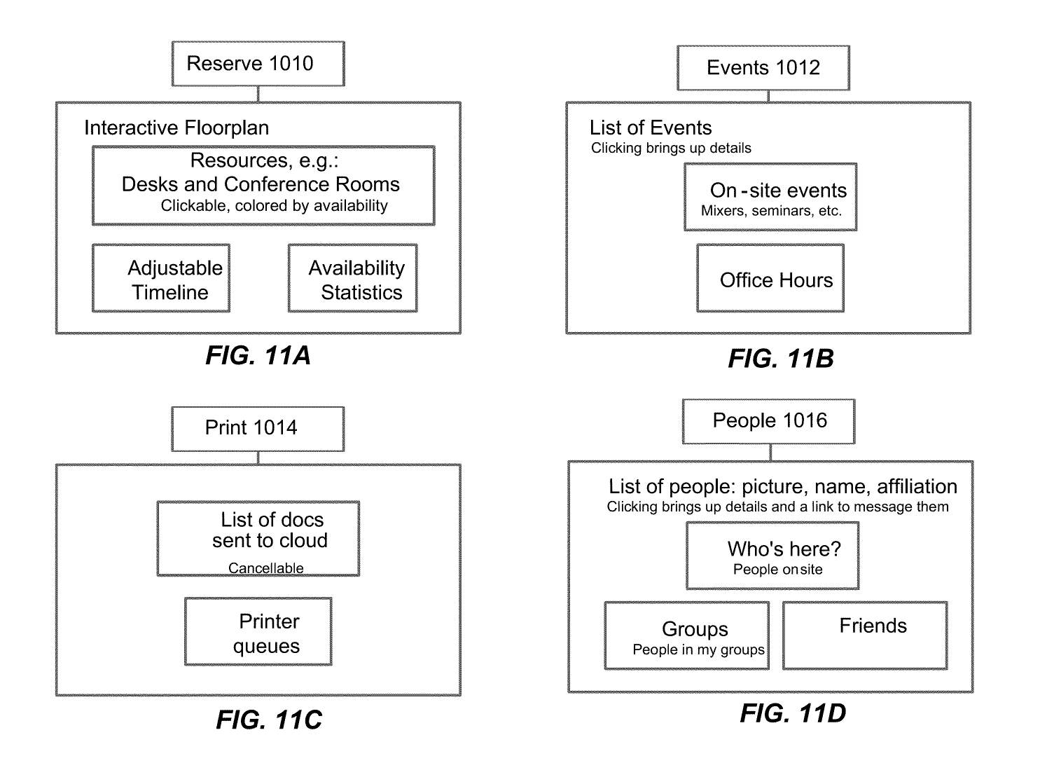

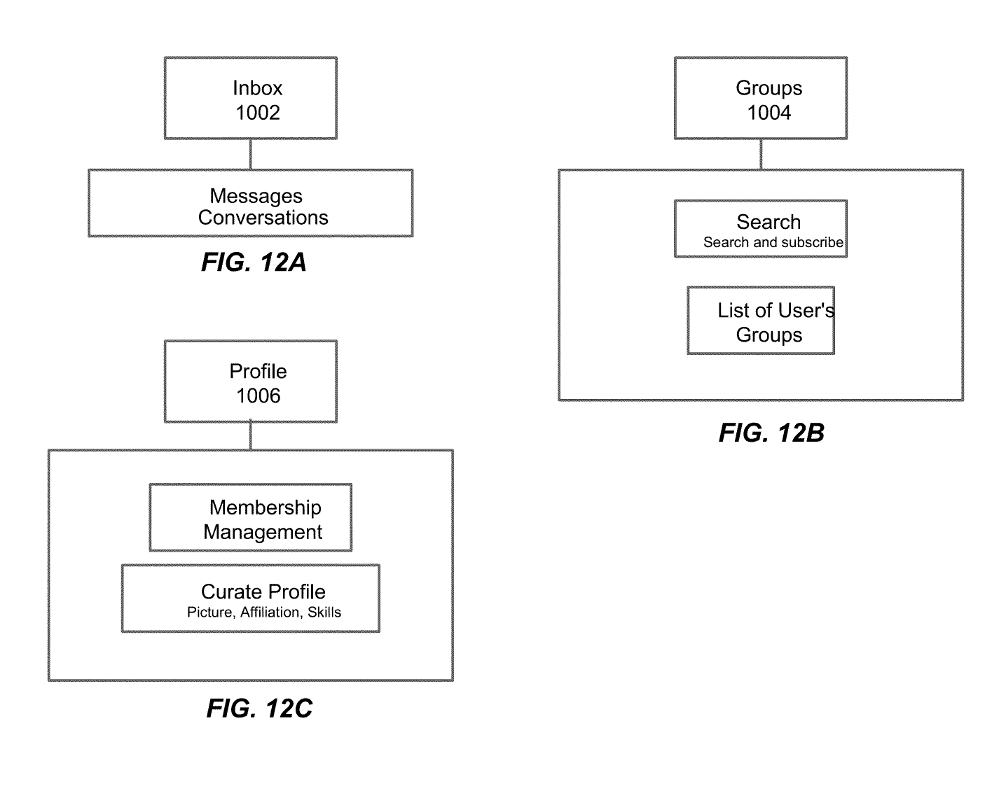

FIG. 10 depicts a high level view of a user interface for on demand business resource management, in accordance with an embodiment of the present disclosure. User interface 1000 may contain one or more user controls for on-demand business resource reservation and social networking. For example, inbox 1002 may be a user interface control allowing a user to navigate to messaging, email, and other communication functionality as described in further detail with respect to FIG. 12A. Groups 1004 may be a user interface control allowing a user to navigate to a social networking groups functionality as described in further detail with respect to FIG. 12B. Profile 1006 may be a user interface control allowing a user to navigate to a user interface for managing their social networking profile as described in further detail with respect to FIG. 12C. Quota information 1008 may provide user account information such as, for example, a quota of remaining desk hours, a printing quota, a number of remaining conference room hours. Clicking on quota information 1008 may provide usage statistics, billing information, payment options, and/or the ability to purchase additional quota resources. Location/change location 1009 may provide one or more location specific controls. As discussed in further detail with respect to FIG. 11A, reserve 1010 may allow a user to navigate to a user interface to reserve a resource, change a reservation, and cancel a reservation. Events 1012 may allow a user to navigate to a user interface providing event information, as discussed in further detail with respect to FIG. 11B. Print 1014 may allow a user to navigate to a user interface for printing and other business services as discussed further with respect to FIG. 11C. People 1016 may navigate to a social networking user interface indicating users at a current business resource location as discussed further with respect to FIG. 11D.

FIGS. 11A-11D depict a user interfaces for on demand business resource management, in accordance with an embodiment of the present disclosure. FIG. 11A depicts user interface reserve 1010, which may allow a user to navigate to a user interface to reserve a resource, change a reservation, and cancel a reservation. Similar to functionality discussed above with respect to FIG. 8, reserve 1010 may provide an interactive floor plan, an adjustable timeline, and availability statistics for resources. FIG. 11B depicts user interface events 1012 which may provide information for on-site events for a currently selected date. Events 1012 may also provide office hour information. FIG. 11C depicts user interface print 1014. Print 1014 may allow a user to navigate to a user interface for printing and other business services. For example, print 1014 may allow a user to select a printer, delete a print job, and manage cloud based storage for a user. FIG. 11D depicts user interface people 1016. People 1016 may provide a social networking user interface providing, for example, a list of people at a business resource location. Additional information such as, for example, a picture, an affiliation may be displayed. Clicking on a person's name, picture or other associated indicator may provide other information and/or options (e.g., a desk location, a link to message them, and profile details). People 1016 may provide a group management user interface allowing a user to create a group, join a group, leave a group, view a list of people in a group, email a group, message a group, view a list of available groups, and other group related functionality. People 1016 may provide a social networking user interface to view friends, contacts, co-workers, or other social networking connections. Functionality may be provided to manage lists or classifications of connections (e.g., to classify a connection as a friend, send an invitation to be listed as a friend, etc.).

FIGS. 12A-12C depict a user interfaces for on demand business resource management, in accordance with an embodiment of the present disclosure. FIG. 12A depicts a user interface inbox 1002 for managing electronic communications (e.g., messages with members of a business resource sharing organization, emails with a business resource sharing organization, and/or posts). FIG. 12B depicts user interface groups 1004 for managing group related functionality including an ability to search for a group, to subscribe to a group, and to search for a user in a group. FIG. 12C depicts user interface profile 1006 which may allow a user to manage membership details and account related functionality. User interface profile 1006 may also provide a user interface for managing an online social networking profile.

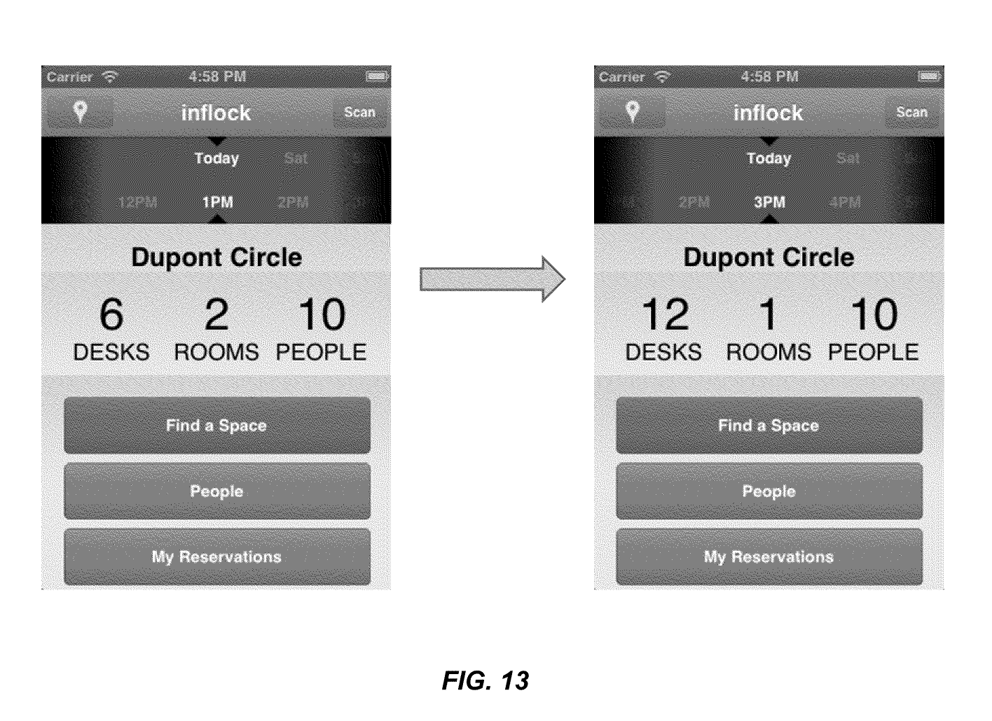

FIG. 13 depicts a user interface for on demand business resource management, in accordance with an embodiment of the present disclosure. As illustrated in FIG. 13, a user interface may provide information about a number of resources used at a particular facility at a particular timeframe. For example, at 1 pm of a current day six desks and two rooms may be reserved and ten people may be scheduled to be present. At three pm the same day a twelve desks and one room may be reserved and ten people may be scheduled to be present. The exemplary user interface of FIG. 13 may allow a user to specify a time frame and view used resources, available resources, or both. The exemplary interface may provide buttons or other user controls allowing navigation to an interface for finding an available space, identifying people with reservations at a facility at a specified time, identifying people checked into a facility at a present time, viewing current reservations, or other functionality. According to some embodiments, FIG. 13 may represent an interface of an application for a user's mobile device. According to some embodiments, FIG. 13, may represent a user interface for a check-in console at a facility.

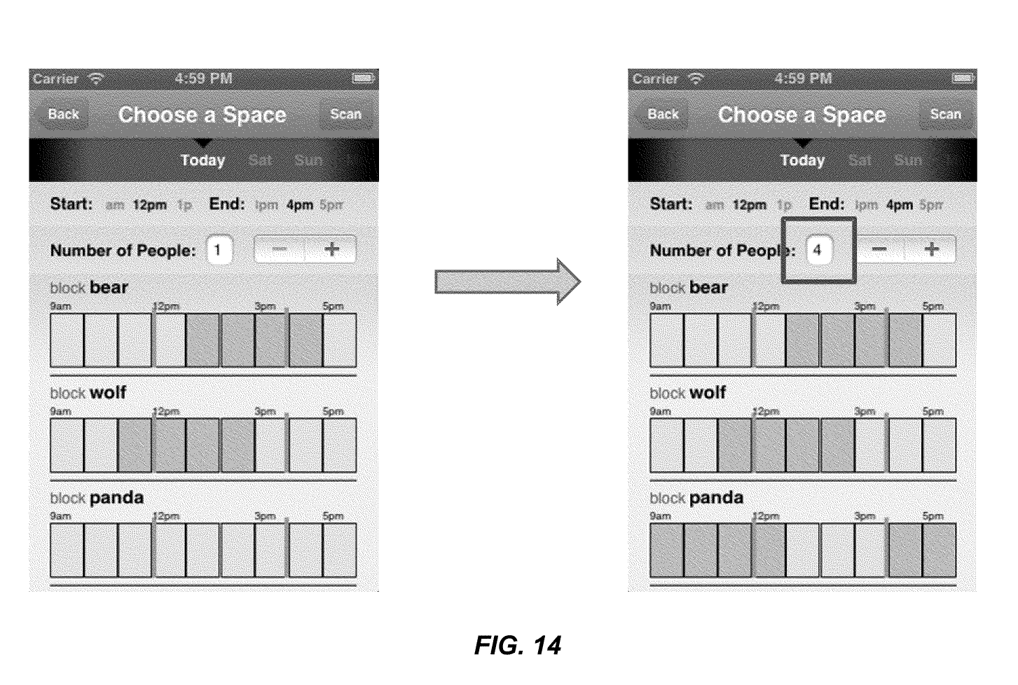

FIG. 14 depicts a user interface for on demand business resource management, in accordance with an embodiment of the present disclosure. As illustrated in FIG. 14, a user interface may provide functionality for reserving blocks of time. A user interface may display reserved and/or available resources for a block of users for a specified period of time. The user interface may allow changing a number of users in a block. Changing a number of users in a block (e.g., from one to four) may decrease the available slots. Changing a time slot desired may increase or decrease a number of available slots for a block. According to some embodiments, a list of available blocks may be displayed and may be presented with labels or other indications of identity (e.g., bear, wolf, panda). Blocks may be affiliated with a group, an enterprise, or another entity. If a user is associated with the group, enterprise, or other entity, and resources are available a user or a block of users may be able to reserve spaces at a same time and/or proximity of an existing block.

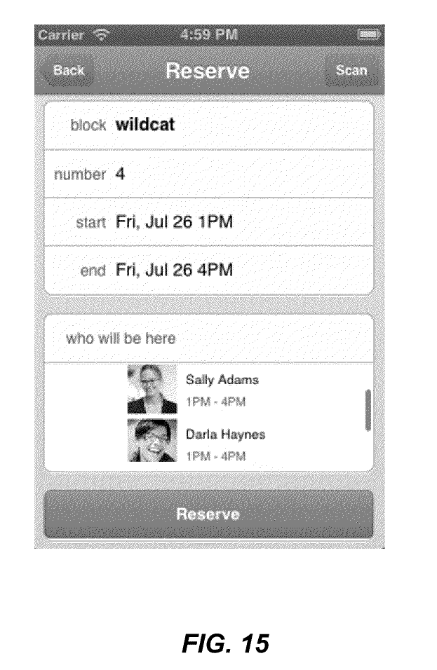

FIG. 15 depicts a user interface for reserving on demand business resources, in accordance with an embodiment of the present disclosure. According to some embodiments, FIG. 15 depicts a user interface for confirming a block reservation for resources. The user interface of FIG. 15 may provide reservation details as well as other information such as for example, other users who have reserved space at a same timeslot.

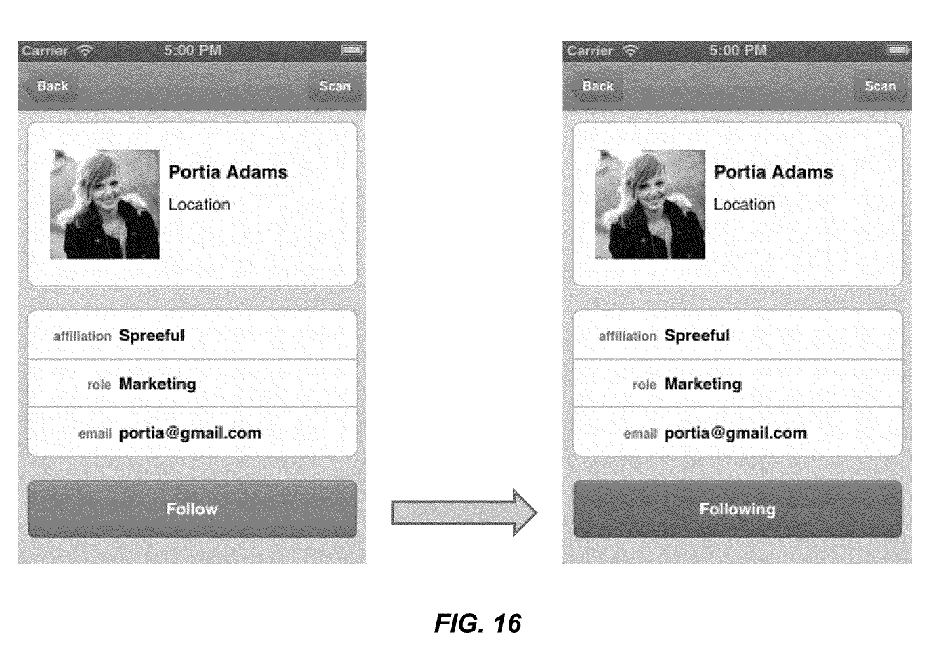

FIG. 16 depicts a user interface for on business networking associated with on-demand business resources, in accordance with an embodiment of the present disclosure. According to some embodiments, FIG. 16 depicts a detail screen for social connection management. The user interface of FIG. 16 may provide functionality for viewing details of a potential social connection and functionality to follow a social connection. Following a social connection may provide updates about a social connection (e.g., current status, checked in to a particular facility, future reservations, posts or messages from a connection, profile information, contact information, etc.). Following a connection may require approval from the connection, may depend on user profile settings, administrator settings, and other factors. According to some embodiments, functionality may be provided to stop following a connection and/or to stop a connection from following a user.

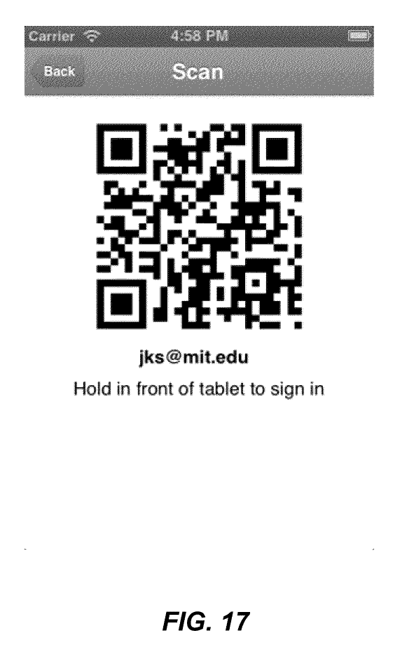

FIG. 17 depicts a user interface for a confirmation code for on demand business resources, in accordance with an embodiment of the present disclosure. A confirmation code may be a QR code, a bar code, or another format. A confirmation code may be scannable and/or transmittable from a user interface. A QR code may provide access to a facility, resources from a vending machine, printing, video conferencing, and/or other services and products. In some embodiments, a QR code may be transmitted via Bluetooth and may provide access to a facility (e.g., unlocking a door).

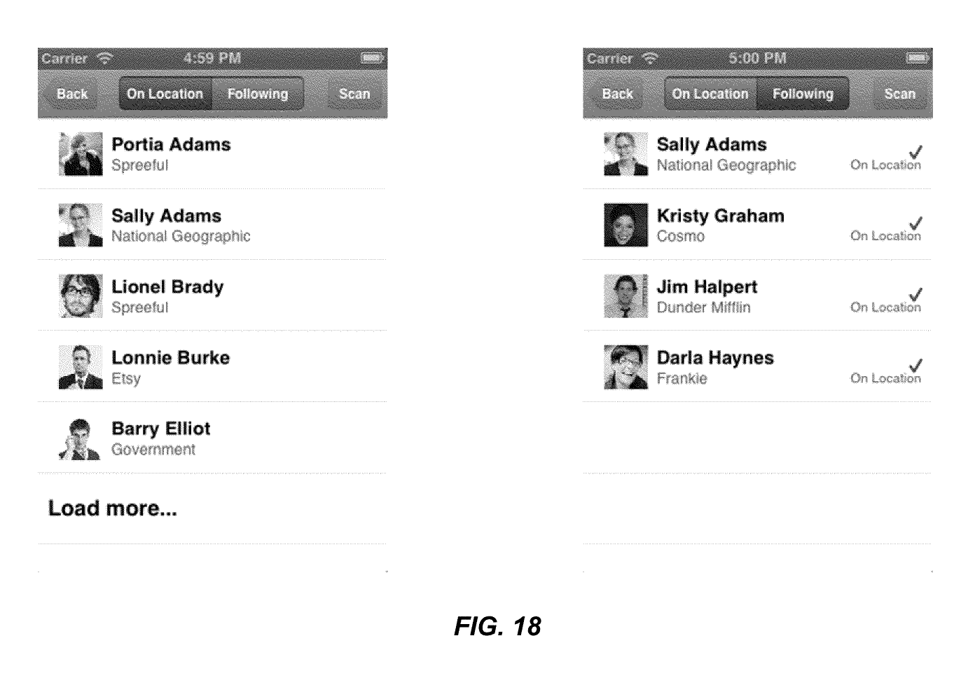

FIG. 18 depicts a user interface for on business networking associated with on-demand business resources, in accordance with an embodiment of the present disclosure. FIG. 18 depicts a user interface showing a list of connections that a particular user is following as well as a list of connections that are currently at a particular location. According to some embodiments, if a user is not on location an indication of when a user is next expected may be provided (e.g., a user's next reserved time slot for a resource at the location).

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method for on demand business resource management comprising
receiving, from a requester, a request via a network for a business resource including at least one of: a workspace, a meeting space, and an event space;
authenticating the requestor;
determining, using at least one computer processor, whether one or more available business resources match the request;
providing an interactive graphical user interface indicating available business resources, wherein the interactive graphical user interface is configured to accept parameters specifying business resources criteria and to update the interactive graphical user interface to indicate available business resources meeting the business resource criteria;
displaying via the graphical user interface indications of one or more people associated with the available business resources;
receiving from the requester, via the graphical user interface, a reservation request for at least one of the available business resources;
reserving the at least one available business resource; and
providing a visual confirmation of the reservation via the graphical user interface.

2. The method of claim 1, wherein the specified business resource criteria comprises a requested block of time for a reservation of an available business resource.

3. The method of claim 2, wherein the requested block of time for a reservation is for less than a twenty-four period.

4. The method of claim 2, wherein the requested block of time for a reservation is for at least one of: a day, a week, a month, and a specified range of time less than a year.

5. The method of claim 1, wherein the one or more people associated with the available business resources comprise people reserving a business resource at a geographical location of the available business resources during a period of time specified by the requester.

6. The method of claim 1, wherein the one or more people associated with the available business resources comprise people reserving a business resource at a geographical location of the available business resources during current period of time.

7. The method of claim 1, wherein the one or more people associated with the available business resources comprise people associated with a group of the requester.

8. The method of claim 1, wherein the graphical user interface displays a map of locations of available business resources.

9. The method of claim 1, wherein the graphical user interface displays a floor plan indicating a layout of business resources, wherein the floor plan indicates available and unavailable business resources for at least one location of available business resources.

10. The method of claim 9, wherein the graphical user interface dynamically updates the displayed floor plan to indicate updated available and unavailable business resources based on one or more factors.

11. The method of claim 10, wherein the one or more factors comprise a change in the specified business resource criteria.

12. The method of claim 11, wherein the change in the specified business resource criteria comprises a change in a requested reservation period received from the requester.

13. The method of claim 11, wherein the change in the specified business resource criteria comprises a reservation received from a second requester.

14. The method of claim 11, wherein the change in the specified business resource criteria comprises a change in a resource type requested by the requester.

15. The method of claim 14, wherein the resource type comprises at least one of a type of workspace, a type of meeting space, a type of event space, a type of collaborative engineering space, and a type of product testing space.

16. The method of claim 1, further comprising:
receiving user profile information from the requester; and
providing social networking functionality using the user profile information.

17. The method of claim 16, wherein the user profile information comprises one or more of: occupation, education, employer, skills, desired skills, desired resources, age, work address, home address, user location information, a friends list, a co-worker list, a team list, a contacts list, a user picture, contact information, employment history, a resume, endorsements by a user, recommendations of a user, business resource payment information, available business resource quota, used business resource quota, and business resource reservation information.

18. The method of claim 16, wherein the user profile information comprises a parameter determining at least one of: user profile privacy, user contact preferences, and marketing preferences.

19. The method of claim 16, wherein the social networking functionality comprises at least one of: groups, messaging, a contacts database, shared documents, group scheduling, document sharing, availability indicators, invitations, notifications, electronic introductions, electronic resumes, professional profile posting, professional profile editing, professional profile searching, mailing lists, crowd-sourcing, and resource sharing.

20. The method of claim 1, further comprising displaying via the graphical user interface indications of one or more events associated with a geographical location of the available business resources.

21. The method of claim 20, wherein the one or more events comprises at least one of: a social event, a lecture, a training, a certification course, and a business meeting.

22. The method of claim 1, wherein business resources comprises at least one of: printing, 3d printer, color printing, personnel, call screening, video conferencing, conference call facilities, whiteboards, office supplies, voicemail, mail boxes, catering, dining facilities, cloud based storage, cloud based backup, a virtual machine, server space, engineering tools, and storage.

23. The method of claim 1, wherein the personnel includes at least one of: a receptionist, a secretary, a document processor, and a graphic artist.

24. The method of claim 1, further comprising:
providing, via the graphical user interface, payment functionality allowing a user to perform one or more of:
pay a business resource management organization for a business resource;
pay a business resource management organization for a service;
pay a user of a business resource management organization for a good; and
pay a user of a business resource management organization for a service.

25. The method of claim 1, further comprising:
providing a loyalty reward to the requester for reservation of and payment for the at least one available business resource.

26. The method of claim 25, wherein the loyalty reward is redeemable at a partner of a business resource management organization holding the reservation request for the requester.

27. An article of manufacture for on demand business resource management, the article of manufacture including at least one non-transitory processor readable storage medium and instructions stored on the at least one medium, wherein the instructions are configured to be readable from the at least one medium by at least one processor and thereby cause the at least one processor to operate so as to:
receive, from a requester, a request via a network for a business resource including at least one of: a workspace, a meeting space, and an event space;
authenticate the requestor;
determine whether one or more available business resources match the request;
provide an interactive graphical user interface indicating available business resources, wherein the interactive graphical user interface is configured to accept parameters specifying business resources criteria and to update the interactive graphical user interface to indicate available business resources meeting the business resource criteria;
display via the graphical user interface indications of one or more people associated with the available business resources;
receive from the requester, via the graphical user interface, a reservation request for at least one of the available business resources;
reserve the at least one available business resource; and
provide a visual confirmation of the reservation via the graphical user interface.

28. A system for on demand business resource management comprising one or more processors communicatively coupled to a network wherein the one or more processors are configured to:
receive, from a requester, a request via a network for a business resource including at least one of: a workspace, a meeting space, and an event space;
authenticate the requestor;
determine whether one or more available business resources match the request;
provide an interactive graphical user interface indicating available business resources, wherein the interactive graphical user interface is configured to accept parameters specifying business resources criteria and to update the interactive graphical user interface to indicate available business resources meeting the business resource criteria;
display via the graphical user interface indications of one or more people associated with the available business resources;
receive from the requester, via the graphical user interface, a reservation request for at least one of the available business resources;
reserve the at least one available business resource; and
provide a visual confirmation of the reservation via the graphical user interface.
